(19) United States
(12) Patent Application Publication
(10) Pub. No.: US 2018/0178226 A1
(43) Pub. Date: Jun. 28, 2018

(54) HIGH-PRESSURE SPRAY NOZZLE ASSEMBLY

(71) Applicant: SPRAY NOZZLE ENGINEERING PTY LTD, Mentone, Victoria (AU)

(72) Inventors: Sean MORGAN, Mentone, Victoria (AU); Stuart MORGAN, Mentone, Victoria (AU)

(21) Appl. No.: 15/735,299

(22) PCT Filed: Jun. 14, 2016
(86) PCT No.: PCT/AU2016/050486

§ 371 Date: Dec. 11, 2017

(30) Foreign Application Priority Data
Jun. 11, 2015 (AU) 2015902412

(51) Int. Cl. B05B 1/34; B05B 1/30; B25B 27/14

(52) U.S. Cl. CPC B05B 1/3426; F16K 15/026; B25B 27/14; B05B 1/3006

(57) ABSTRACT

A high-pressure spray nozzle assembly (10) has a nozzle body (20) and nozzle cap (30), which are operatively coupled and co-operatively house a retainer (40) having a clasp (42) for retaining wear components (50). The nozzle cap (30) has an open-stepped detent (32) formed in relief on an internal peripheral surface of the nozzle cap (30), which operatively permits sealing of the retainer (40) against the nozzle cap (30) as a consequence of hydraulic pressure applied by fluid delivered through the spray nozzle assembly (10).

### TECHNICAL FIELD

The invention relates to spray nozzle assemblies, specifically high-pressure spray nozzle assemblies used for spray drying applications.

### BACKGROUND ART

High-pressure spray nozzles used for spray drying have many applications, such as for spray drying of dairy products. Spray nozzles operate under high-pressure—typically 3,000 psi or more, and often as much as 5,000 psi and up to 10,000 psi. Spray nozzle assemblies should accordingly be engineered to conform to appropriate agreed technical standards governing high-pressure equipment, such as ASME B31.3.

Existing designs are, however, thought to be non-compliant for various reasons. One root cause is that existing designs dictate various manufacturing tolerances to avoid components jamming axially and radially. Such compromises demanded of existing designs inherently reduce the suitability of such designs for high pressure operation.

The use of non-compliant high-pressure equipment represents a serious safety issue in an industrial setting, as failure of high-pressure equipment may have catastrophic consequences, including fire and explosion risk. Moreover, nozzle assembly failure has implications for plant productivity and product quality control.

Directly linked to safety and productivity concerns, spray nozzle assemblies of this type also have requirements of improved operator usability. The ease of operation in disassembling a spray nozzle and replacing its consumable wear components affects operational usability, efficiency and risk arising from incorrect assembly.

Ideally, spray nozzles should maintain operational safety via compliance with high-pressure equipment standards, along with reliably producing a precise spray pattern for product quality, ready cleanablility, and permit operators to readily replace wear components without damaging the spray nozzle assembly.

An objective of the present invention is to at least partly address these and other limitations of existing designs, or at least provide a useful alternative.

### SUMMARY OF INVENTION

The present invention, in one aspect, arises from a realization that effective sealing in high-pressure spray nozzle assembles can be advantageously achieved by leveraging applied hydraulic pressure to avoid inherent possibilities of high-pressure failure that are present in some existing designs.

Accordingly, the present inventors have devised a high-pressure spray nozzle assembly having a nozzle body and nozzle cap, which are operatively coupled and co-operatively house a retainer having a clasp for retaining wear components, wherein the nozzle cap has an open-stepped detent which is formed in relief on an internal peripheral surface of the nozzle cap, wherein the open-stepped detent permits sealing of the retainer against the nozzle cap as a consequence of hydraulic pressure applied by fluid delivered through the high-pressure spray nozzle assembly during operation.

The retainer features a retaining seal located upstream of the clasp and disposed around a radial periphery of the retainer. The retaining seal serves to register the retainer within the nozzle cap by interference of the retaining seal with the open-stepped detent.

The retainer is not restricted in an absolutely fixed position by the open stepped detent, and enjoys a limited amount of travel or play along an axial direction of the nozzle cap. The retainer by design responds to applied hydraulic pressure to complete effective sealing via mating internal surfaces of the nozzle cap and the retainer.

Preferably, a front axial orifice seal is positioned on the wear components and becomes further compressed with increasing hydraulic pressure through the assembly, which acts to create a secure mating surface seal between the wear components and the nozzle cap under operating hydraulic pressure.

The retaining seal is preferably larger in section than the front axial orifice seal positioned on the wear components, and is also preferably made of a material that is stiffer and harder than that of the front axial orifice seal. The retaining seal does not provide a high-pressure sealing function itself, but effects registration of the retainer in the nozzle cap, and sealing is completed by applied hydraulic pressure arising via normal operation.

The retainer preferably has a perforated sleeve integral or attached to the clasp, and which protrudes from the nozzle cap when the retainer is registered within. The sleeve has at least one pair of opposed lateral bores formed therein to facilitate extraction of the retainer from the nozzle cap.

The present invention in a further aspect comprise a unitary retainer assembly for a high-pressure spray nozzle assembly of the type described herein, the unitary retainer assembly comprising: a retainer having a clasp for releasably trapping wear components, and a sleeve having a radial detent; a check valve assembly comprising a valve seal attached to a valve body having a radial detent; and a helical spring which at one terminal end removably attaches to the radial detent formed on the sleeve of the retainer, and at its opposite terminal end removably attaches to the radial detent formed on the valve body of the check valve.

The check valve assembly is releasably attached to the retainer, wherein the sleeve acts to guide the valve spring in axial alignment with the assembly while the clasp receives and retains the wear components. The retainer integrates a check valve assembly to form the unitary retainer assembly.

The sleeve of the retainer comprises a spring retaining barb locator acting as a detent internally to ensure the valve spring and valve body and seat of the check valve remain attached to each other on removal of the nozzle cap, thereby preventing these parts and the valve spring from being free to fall out and potentially get lost during disassembly of the spray nozzle assembly.

The present invention in a yet further aspect provides an extraction tool for use in connection with the high-pressure spray nozzle assembly, for extracting the retainer from the nozzle cap when the retainer is registered within the nozzle cap, the extraction tool comprising a barrel terminating at an upper end in a peripheral collar for seating the nozzle cap so that the retainer depends downwardly into the barrel from the nozzle cap, the barrel having near the collar a pair of channels formed through the peripheral wall of the barrel, the channels being diametrically offset along their extent operatively to permit a pin of a hand tool to pass through respective channels so that the pin moves downwardly as it is rotates along the channels.

A sleeve integral with a retainer that projects beyond the open end of the nozzle cap permits effective use of the extraction tool. A perforated sleeve provides a means by which the retainer can be extracted from the nozzle cap under controlled conditions using a hand tool with the extraction.

### BRIEF DESCRIPTION OF DRAWINGS

FIGS. 1A and 1B are complementary perspective views—in exploded form—of components of an example high-pressure spray nozzle assembly which features an embodiment of the present invention.

FIG. 1C are perspective views—in assembled form—of the example high-pressure spray nozzle assembly of FIGS. 1A and 1B.

FIG. 2A is a cross-sectional view of the high-pressure spray nozzle assembly—in assembled form—depicted in FIG. 1, taken through a central axis, together with two accompanying details focussing as indicated on a retaining seal (detail X, FIG. 2B) and also a valve spring (detail Y, FIG. 2C).

FIG. 3 depicts cross-sectional views similar to that of FIG. 2 of different example high-pressure spray nozzle assemblies.

FIG. 4 depicts complementary perspective views of an extraction tool that can be used in conjunction with the high-pressure spray nozzle assembly of FIG. 1 for extracting a retainer from a nozzle cap, and corresponding perspective views of FIG. 5 depict progressive sequential steps involved in removing the retainer from the nozzle cap using a suitable hand tool in conjunction with the extraction tool of FIG. 4.

### DESCRIPTION OF EMBODIMENTS

A preferred embodiment of the present invention is described below with reference to the accompanying drawings.

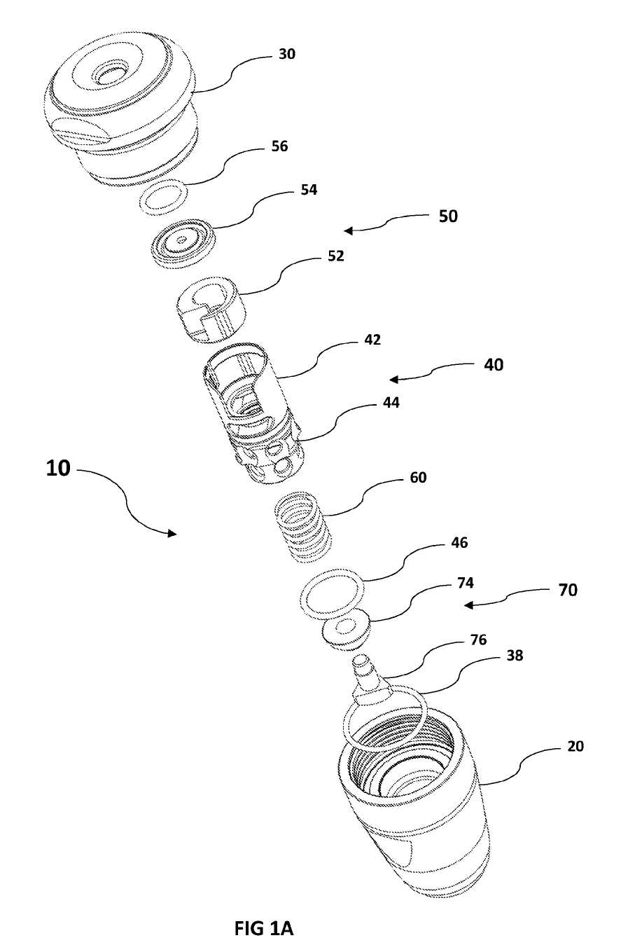

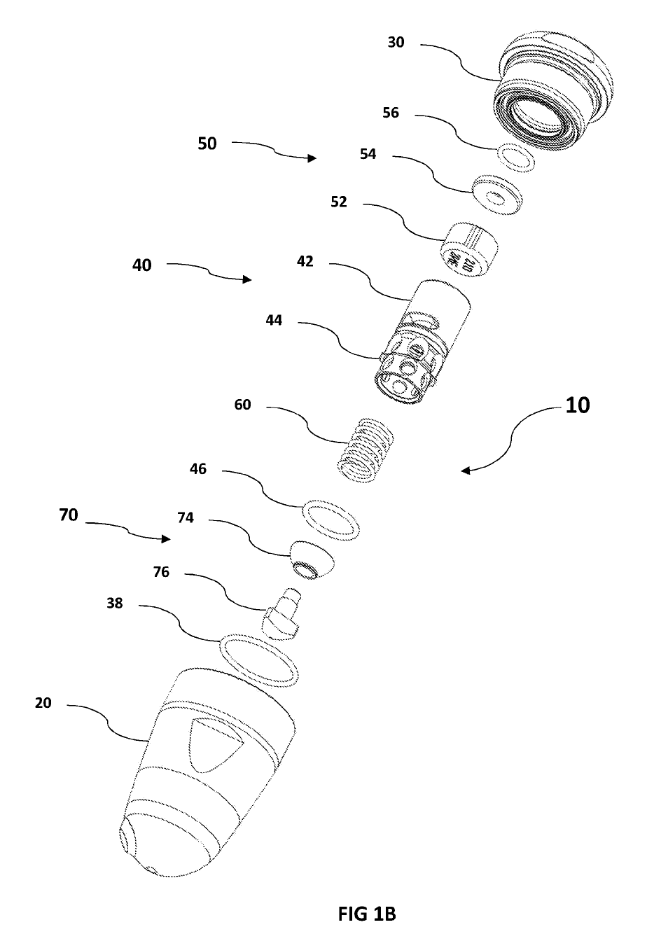

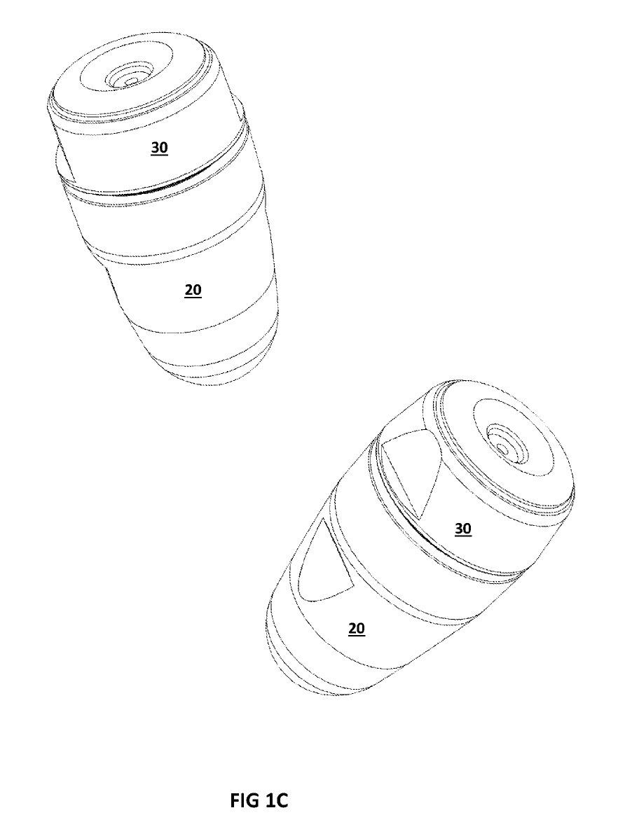

FIG. 1 depicts via various perspective views a high-pressure spray nozzle assembly 10 in exploded form (FIGS. 1A and 1B), and also assembled form (FIGS. 1C and 1D). An earlier generation of this general type of high-pressure spray nozzle assembly in the name of the present applicant is described in U.S. Pat. Nos. 9,027,860, and 9,027,861 both of 2015 May 12: the contents of both of these publications are incorporated herein by reference in their entirety.

The high-pressure spray nozzle assembly 10 comprises as primary components a nozzle body 20, a nozzle cap 30, and a retainer 40. When assembled, the body 20 and cap 30 co-operatively house the retainer 40, which is registered in the nozzle body 30. The nozzle body 20 and nozzle cap 30 are more particularly operatively coupled, via co-operating screw threaded engagement. The nozzle cap 30 features a radial seal located in a groove formed in a peripheral surface of the nozzle cap 30 for effective sealing between the nozzle cap 30 and the nozzle body 20 when the nozzle body 30 is screw threaded onto the nozzle cap 30, after the retainer 40 has been registered into the nozzle cap 30. Certain aspects of this general arrangement are further described in U.S. patent application Ser. No. 13/990,708, which is published as US20140048630 A1, the disclosure of which is hereby incorporated by reference in its entirety. Operatively, pressurised fluid is delivered at an upstream end of the assembly 10, and exits the assembly as an atomised mist at a downstream end of the assembly 10.

The retainer 40 at one (downstream) end features a clasp 42, which receives wear components 50 in releasably trapped engagement. The wear components 50 in this case comprise a co-operating swirl chamber 52 capped by an orifice disc 54, both formed of hard-wearing tungsten carbide. The assembly 10 features at least one pair of co-operating keys and keyways formed in the wear components 50 and clasp 42, and the co-operating keys and keyways are asymmetrically spaced to force correct orientation of the wear components 50. Co-operating keys and keyways can be used on the wear components 50 and the clasp 42. Preferably, the keys and keyways are asymmetrically placed to avoid incorrect insertion. This ensures correct registration and orientation of the wear components 50, and avoids radial and axial rotation as well as improving the structural integrity of the clasp 42 as the keys effectively form reinforcing members by way of webs on the structure of the clasp 42. This avoids the operator being able to insert the wear components 50 ‘upside down’, which would result in a dead end, and hence potential failure of the assembly 10.

The keys and keyways can be strategically positioned to prevent the swirl chamber 52 from inadvertently being installed upside down, since the multiplicity of registration and the varying spacing between these code the swirl chamber 52 to one mode of installation only, and accordingly the wear components 50 are unable to be installed in an incorrect orientation.

Certain aspects of the general arrangement of the wear components 50 trapped within a retainer 40, and more particularly the clasp 42 of the retainer 40, and the associated advantages of such an arrangement, is as described in U.S. Pat. Nos. 9,027,860 and 9,027,861, referred to above.

The orifice disc 54 has a groove formed therein for receiving an axial seal 56. The general arrangement of the axial seal 56, which co-operates with the orifice disc 54 is described in further detail in U.S. patent application Ser. No. 13/378,793 (published as US20120153577 A1), the disclosure of which is hereby incorporated by reference in its entirety.

The retainer 40 also comprises a sleeve 44 integral or at least attached to the clasp 42. While the clasp 42 receives and retains the wear components 50, the sleeve fulfils a different role—that of retaining and guiding valve spring 60, which is attached to check valve assembly 70. Check valve assembly 70 comprises a valve body 72, a valve seal 74 and valve guide 76. The valve seal 74 is secured between the valve body 72 and valve guide 76 by co-operating screw-threaded engagement.

As depicted, the sleeve 44 of the preferred embodiment is segmented into two parts. As is apparent, a wider bore segment of the sleeve 44 is located adjacent the clasp 42, while a narrower bore segment terminates the sleeve 44 at an upstream end of the retainer 40. Both segments are generally circular in configuration. Moreover, both segments of the sleeve 44 are perforated, preferably with a pattern of holes having pairs arranged in diametric opposition, as is described in further detail below.

The sleeve 44 is stepped as depicted to catch an opposing shoulder formed on an internal surface of the nozzle body 20. This acts to prevent any excessive backward movement (‘kickback’) of the retainer 40 when the assembly 10 becomes operational following pressurisation. As an example, backward movement can be contained to within 0.05 mm using this arrangement.

The sleeve 44 retains the valve spring 60, which is releasably attached in use to the check valve assembly 70, via a radial detent formed in relief on the valve body 72. The check valve assembly 70 co-operates with the nozzle body 20, and more particularly its upstream opening to discourage any dripping by operation of the valve seal 74. The sleeve 44 also collimates the valve spring 60 to ensure that the valve spring 60 is guided in a linearly reciprocating path in alignment with the axial direction of the assembly 10. The general arrangement of a check valve assembly 70 and valve spring 60 is described in U.S. Pat. No. 8,596,560, the disclosure of which is hereby incorporated by reference in its entirety.

The arrangement of the preferred embodiment depicted retains the check valve assembly 70 on the retainer 40, via the valve spring 60, and the retainer 40 is registered in the nozzle cap 30 until extracted. This has manifold advantages, as will be apparent to those skilled in the art. A unitary retainer assembly, comprising the retainer 40, valve spring 60 and check valve assembly 70, can be handled as a single workpiece until disassembly, which avoids loss of components when assembling the high-pressure spray nozzle assembly 10.

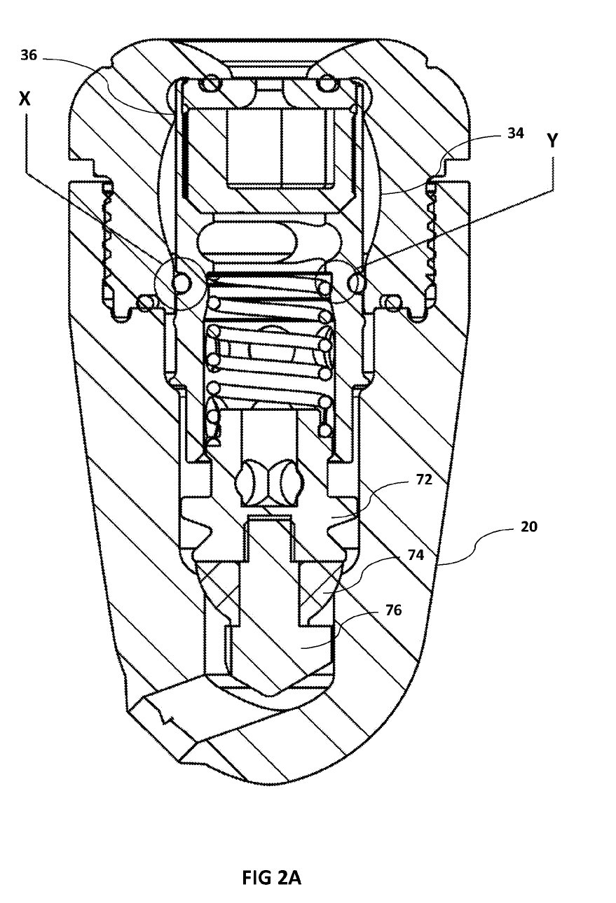

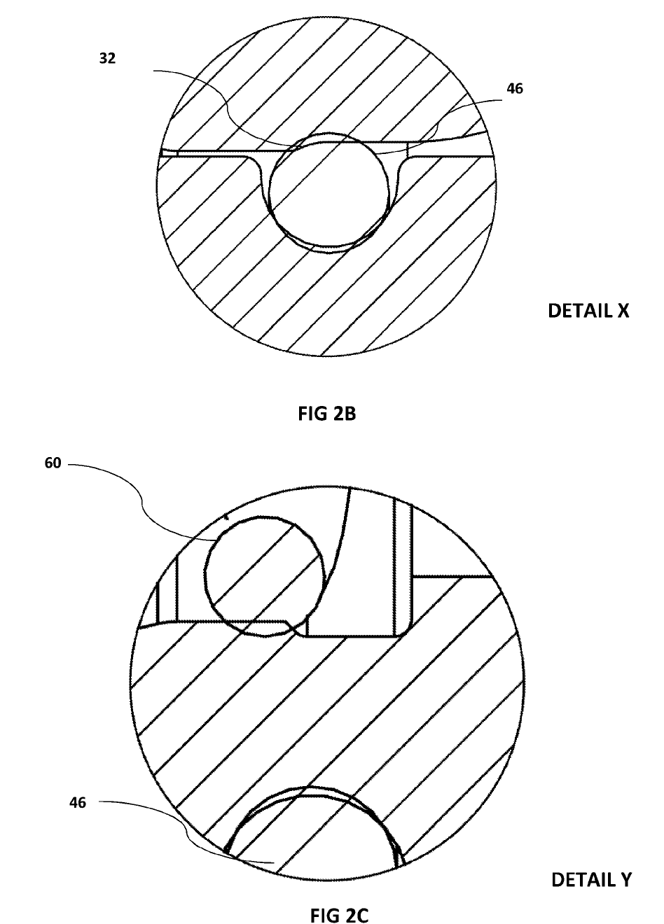

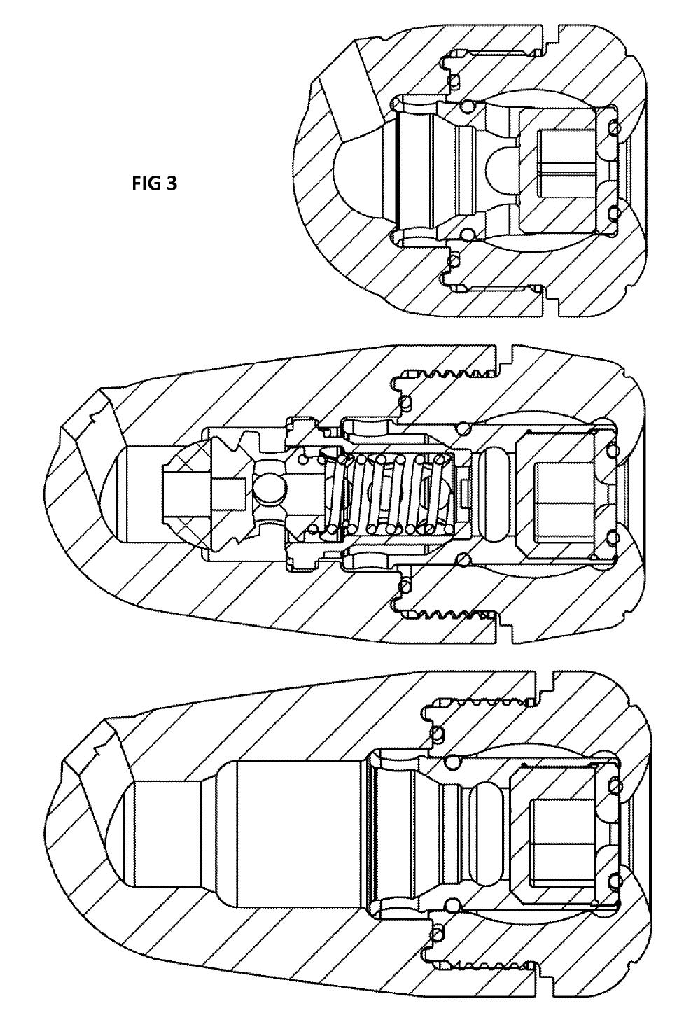

FIG. 2 depicts the embodiment of the assembly 10 of FIG. 1, though in sectional and assembled form, with particular details X and Y indicated in FIG. 2A exploded as FIGS. 2B and 2C respectively.

Detail X depicts the relationship between the retaining seal 46 on the retainer 40, and the nozzle cap 30 and more particularly the open-stepped detent 32, which is formed as a peripheral shoulder formed in relief on an internal surface of the nozzle cap 30. The open-stepped detent 32 on the nozzle cap 30 flares open in the region in which the retaining seal 46 is ordinarily located when the retainer 40 is registered in the nozzle cap 30.

Detail Y indicates an inner peripheral corner of the sleeve 44 features a radial detent formed in relief that locates and retains the end of the valve spring 60. A similar radial detent is provided on the valve body 72, though on its external surface, so that the valve spring 60 can be removably attached as required to both the retainer 40 and the check valve assembly 70.

This has the particular advantage that the valve spring 60 (and attached check valve assembly 70) does not fall out of the sleeve 44 during disassembly of the assembly 10. Operational environments in which spray nozzles are deployed cannot tolerate disruption which may result from misplaced components, or consequent damage. Furthermore, spray nozzle application are often food-related, which require strict control over hygiene.

The retaining seal 46 is provided in the form of a suitably sized O-ring, matched to the gland formed the retainer 40, in which the seal 46 is seated. The retaining seal 46 preferably has a higher order duro or hardness rating than that of the axial seal 56. This means, in effect, that the retaining seal 46 is of a denser material to encourage sealing integrity. The axial seal 56 in operation is thus readily compressed against the inner face of the nozzle cap 30, to provide surface-to-surface contact between wear components and the nozzle cap 30. The hardness of the retaining seal 46 contributes to a ‘pre-loading’ of the retainer 40 within the nozzle cap 30, which also contributes to the sealing integrity.

The relevant co-operating geometry of the cap 30 and retainer 40 is found to result in a distinct and satisfying ‘click’ when the retainer 40 is registered in the nozzle cap 30, thus providing an audible confirmation of correct registration of components. Lack of such auditory confirmation may be indicative of mis-assembly, such as by way of a slipped retaining seal 46. The open-stepped detent 32 and relief belt 34 also allows for effective access and cleaning, which ensures reliable operation and hygiene.

Referring to FIG. 2B, the open stepped detent 32 has a stepped height, which is in the region of an indicative value of 0.2 mm in the preferred embodiment. Other heights may be adopted for more or less positive detent action, as may be required in different applications. The open stepped detent 32 has an indicative fillet radius of 1 mm, which co-operates with the retaining seal 46, which has a matching nominal diameter of 2 mm in the construction indicated. The start of the open-stepped detent 32 is radiused at 0.5 mm to prevent pinching the retaining seal 46.

The radius of the gland of the retaining seal 46 is slightly larger (say 1.4 mm), which permits some limited travel of the retaining seal 46 within the cavity, which creates bias on the downstream side of the open-stepped detent 32.

The geometry described above, and depicted in FIG. 2B results in an arrangement in which the total radial gap between the base of the step and the bottom of the gland of the retaining seal 46 is 1.75 mm, thus significantly compressing retaining seal 46 by 0.25 mm. This is found to provide a positive detent action mitigating axial slip.

Referring back to FIG. 2A in particular, a relief belt 34 is formed in the internal nozzle cap 30 downstream of the open-stepped detent 32, and serves to relieve pressure, and also has hygiene advantages owing to ease of cleaning of deposits. The relief profile 34 preferably has a hemispherical profile and shape, though other profiles can be used. The relief belt 34 terminates in a throat 36 which pinches the retainer 40, and serves to collimate the retainer 40 in the cap 30, and also to ensure that the wear components 50 are securely held by the clasp 42 of the retainer 40.

As will be appreciated from the foregoing, the configuration of the open-stepped detent 32 means that bore of the cap 30 opens slightly to a larger diameter to better accommodate the retainer 40. The open-stepped detent 32 is open in the sense that the geometry of the cap 30 provides no obstruction to applied hydraulic pressure to force the retainer 40 firmly against the cap 30.

FIG. 3 depict in sectional views similar to FIG. 2A of different configurations of assemblies which also features a similarly constructed open-stepped detent as well as other corresponding features. As will be appreciated, different assemblies better suit specific applications.

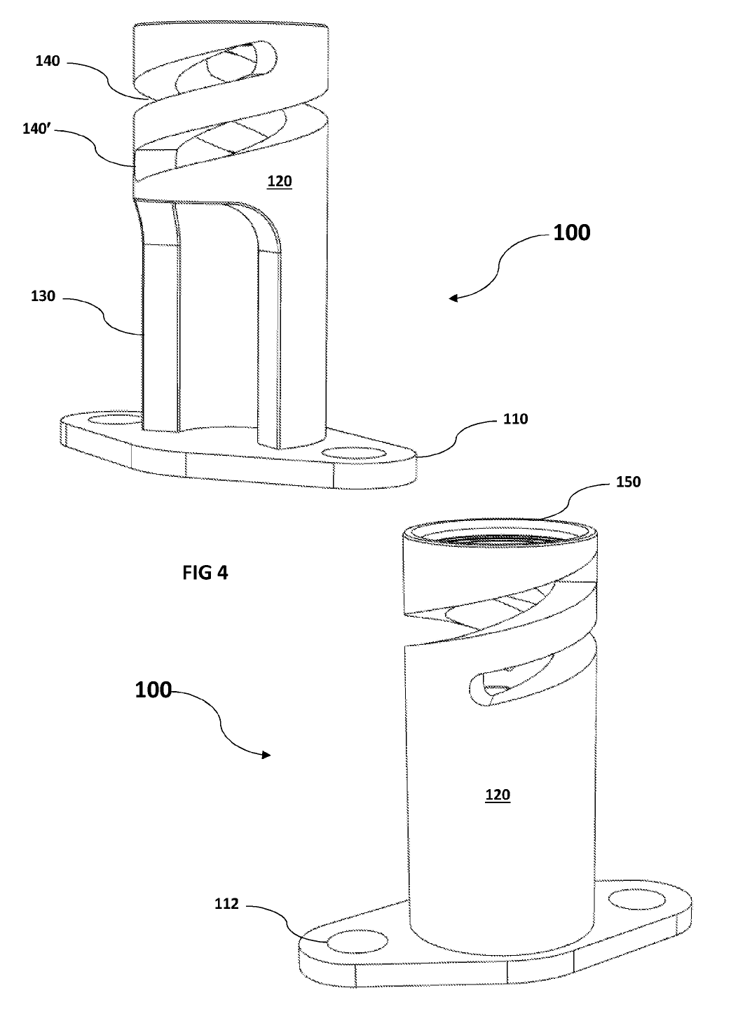

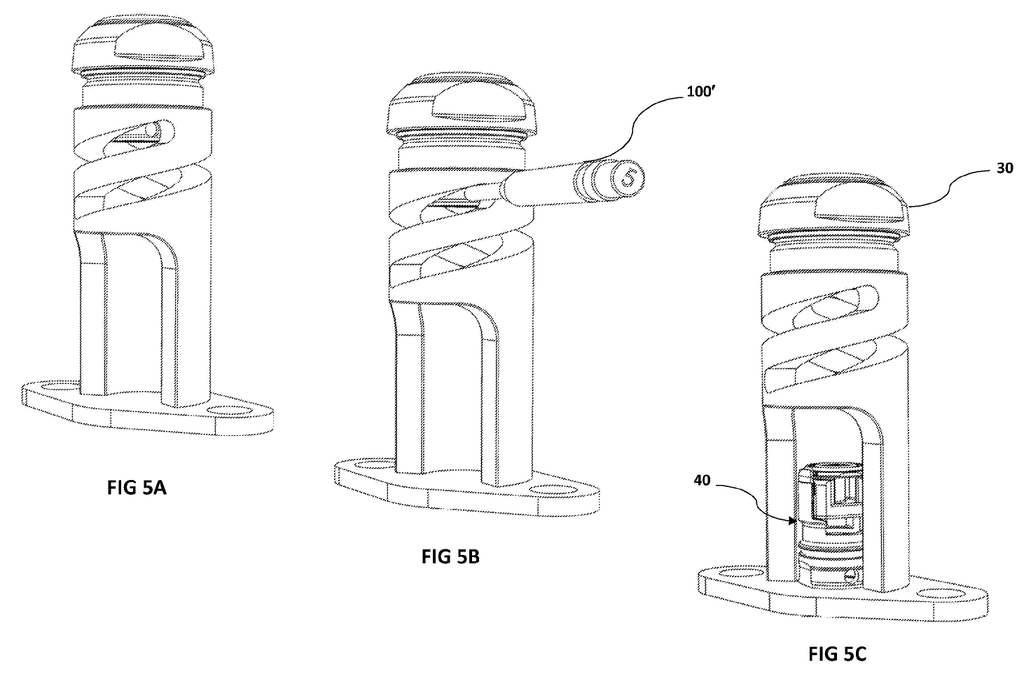

FIG. 4 depicts an extraction tool 100 in complementary perspective views that can be used with the assembly 10 described above in connection with accompanying FIGS. 1 and 2.

An extraction tool 100 is advisable as typical use of assembly 10 involves high pressures and temperatures, which can consequently result in gumming and baking of deposits on internal surfaces. As a consequence, using positive controlled force to extract the retainer 40 from the cap 30 separates these components without damage.

Accordingly, the extraction tool 100, as described below, achieve extraction without direct (uncontrolled) manual contact with the retainer 40, or indeed the nozzle cap 30. This avoids damaging the wear components 50 and the nozzle cap 30.

The extraction tool 100 is used in conjunction with a screwdriver-like hand tool having a simple handle and a pin projecting from the handle, as indicated. A suitable sized handled screwdriver or like to assist extraction of the retainer 40 as a workaround.

A barrel 120 of the tool 100 is attached to a base 110 having a central bore and an opening 130 on one side adjacent the base 110. The collar 150 is open, and is finished to receive and engage a periphery of the nozzle cap 30 in use—as depicted in FIGS. 8A to 8C.

The base 110 preferably has holes 112 formed therein for secure attachment to a workbench, wall or other surface.

The barrel 120 has formed therethrough its peripheral wall a pair of channels 140, 140′ is arranged as depicted an arc around the barrel 120.

FIG. 5, by way of progressive sequential views of FIGS. 5A, 5B and 5C convey steps involved in using the extraction tool 100 and the accompanying hand tool 100′.

Removal of the retainer 40 from the cap 30 is progressively achieved by the steps figuratively depicted in these views.

First, in FIG. 5A, the nozzle cap 30 is fitted to the extraction tool 100 by seating the cap 30 on the collar 150. The retainer 40 is still fitted to the nozzle cap 30, and is visible in FIG. 5A through channel 140, though not especially apparent without closer inspection.

The peripheral profile of the collar 150, visible in FIG. 4, is machined to snugly seat with the corresponding exposed lower profile of the cap 30, namely its skirt wall and adjacent seal.

With the cap 30 and retainer placed in the tool 100, the hand tool 100′ can be introduced—as depicted in FIG. 5B. The pin of the hand tool 100′ fitted through the opposed channels 140 in the barrel 130 of the hand tool 100′, and also the opposed holes described and depicted in the sleeve 44 of the retainer 40. The pin of the hand tool 100′ thus securely captures the retainer 40. The cap 30 can if necessary be rotated manually to achieve proper alignment with the pin as required, preliminary to insertion.

Once registered through the retainer 40 via a passage afforded by the perforations in the sleeve 44, the pin can be pivoted around and downwardly—following the curvature of the opposed channels 140 formed in the barrel of the tool 100, this pulling retainer 40 and cap 30 apart in a controlled manner. The hand tool 100′ is then withdrawn, as depicted in FIG. 5C, and the retainer 40 is unsupported, and so fall downs the barrel 130 where it can be removed from the tool 100.

Various modifications of the preferred and alternative embodiments described herein and depicted in the accompanying figures are possible, as would be apparent to a person skilled in the art.

1. A high-pressure spray nozzle assembly having a nozzle body and nozzle cap, which are operatively coupled and co-operatively house a retainer having a clasp for retaining wear components, wherein the nozzle cap has an open-stepped detent which is formed in relief on an internal peripheral surface of the nozzle cap, wherein the open-stepped detent permits sealing of the retainer against the nozzle cap as a consequence of hydraulic pressure applied by fluid delivered through the high-pressure spray nozzle assembly during operation.

2. The high-pressure spray nozzle assembly according to claim 1, wherein the retainer has a retaining seal which is disposed around a radial periphery of the retainer, and which registers the retainer in the nozzle cap by interference with the open-stepped detent.

3. The high-pressure spray nozzle assembly according to claim 1, wherein wear components retained by the clasp are matingly sealed against an internal surface of the nozzle cap during operation.

4. The high-pressure spray nozzle assembly according to claim 1, wherein the nozzle cap has downstream of the open-stepped detent a relief belt formed peripherally around an internal surface of the nozzle cap.

5. The high-pressure spray nozzle assembly according to claim 1, wherein the relief belt is shaped to be generally hemispherical in sectional profile to form a void between the nozzle cap and the retainer when registered within the nozzle cap.

6. The high-pressure spray nozzle assembly according to claim 1, wherein the wear components comprise a swirl chamber and an orifice disc operatively mated and removably trapped by the clasp of the retainer.

7. The high-pressure spray nozzle assembly according to claim 6, wherein co-operating keys and keyways formed on the clasp and wear components are asymmetrically spaced to force correct orientation of the wear components with the clasp.

8. The high-pressure spray nozzle assembly according to claim 1, wherein the retainer has a sleeve which extends beyond an upstream opening of the nozzle cap, and having at least one lateral bore formed therein to facilitate extraction of the clasp from the nozzle cap.

9. The high-pressure spray nozzle assembly according to claim 8, wherein the sleeve has a detent for receiving a helical spring associated with a check valve.

10. The high-pressure spray nozzle assembly according to claim 1, further comprising a check valve releasably attached to the retainer, wherein the sleeve acts to guide the valve spring in axial alignment with the assembly.

11. The high-pressure spray nozzle assembly according to claim 1, wherein the nozzle body and nozzle cap are operatively coupled via co-operating screw-threaded engagement in which the nozzle cap is screwed into the nozzle body, and sealing is effected between the nozzle cap and nozzle body via an axial seal in the form of a guarded O-ring gland formed in a peripheral flange of the nozzle cap.

12. A unitary retainer assembly for a high-pressure spray nozzle assembly comprising: a retainer having a clasp for releasably trapping wear components, and a sleeve having a radial detent; a check valve assembly comprising a valve seal attached to a valve body having a radial detent; and a helical spring which at one terminal end removably attaches to the radial detent formed on the sleeve of the retainer, and at its opposite terminal end removably attaches to the radial detent formed on the valve body of the check valve.

13. The unitary retainer assembly of claim 12, wherein the sleeve is perforated, and stepped inwardly at its terminal end to serve as a guide for the valve body of the check valve assembly.

14. The unitary retainer assembly of claim 12, wherein the radial detent formed in the sleeve is formed on an internal surface within the sleeve, and the radial detent formed in the valve body is formed on an external surface thereof.

15. An extraction tool for use in connection with the high-pressure spray nozzle assembly of claim 1, for extracting the retainer from the nozzle cap when the retainer is registered within the nozzle cap, the extraction tool comprising a barrel terminating at an upper end in a peripheral collar for seating the nozzle cap so that the retainer depends downwardly into the barrel from the nozzle cap, the barrel having near the collar a pair of channels formed through the peripheral wall of the barrel, the opposed channels being diametrically opposed in corresponding positions along their extent operatively to permit a pin of a hand tool to pass through the respective channels for extraction of the retainer from the nozzle cap.
